(19) United States
(12) Patent Application Publication
(10) Pub. No.: US 2020/0177645 A1
(43) Pub. Date: Jun. 4, 2020

(54) CONTENT MANAGEMENT SERVER, INFORMATION SHARING SYSTEM, AND COMMUNICATION CONTROL METHOD

(71) Applicant: Eiichiro YOSHIDA, Kanagawa (JP)

(72) Inventor: Eiichiro YOSHIDA, Kanagawa (JP)

(21) Appl. No.: 16/697,827

(22) Filed: Nov. 27, 2019

(30) Foreign Application Priority Data
Nov. 30, 2018 (JP) 2018-225298
Nov. 22, 2019 (JP) 2019-211031

(51) Int. Cl. H04L 29/06; G06Q 10/10

(52) U.S. Cl. CPC H04L 65/1093; G06Q 10/1095; H04L 65/1069

(57) ABSTRACT

A content management server, an information sharing system, and a communication control method. The content management server for managing data of content shared by a plurality of communication terminals in a virtual room, the plurality of communication terminals include a first communication terminal and a second communication terminal, receives an invitation transmission request indicating a request to transmit an invitation for participating in the virtual room to the second communication terminal from the first communication terminal, and causes the second communication terminal to participate in the virtual room in response to receiving a participation request indicating a request for participation in the virtual room transmitted by the second communication terminal.

### CROSS-REFERENCE TO RELATED APPLICATIONS

This patent application is based on and claims priority pursuant to 35 U.S.C. § 119(a) to Japanese Patent Applications No. 2018-225298, filed on Nov. 30, 2018 and No. 2019-211031 filed on Nov. 22, 2019 in the Japan Patent Office, the entire disclosure of which is hereby incorporated by reference herein.

### BACKGROUND

### Technical Field

The present disclosure relates to a content management server, an information sharing system, and a communication control method.

### Background Art

In recent years, telework using an information and communication technology (ICT) has been adopted, which allows employees to work flexibly without being restricted by where and when the employees work. To allow persons at different remote places to join a conference or a meeting even when one or more of the participants work remotely, materials or documents used in the conference or meeting are shared through a communication network or a video conference is held using the communication network. In this case, a sever sets up a virtual room. Users who have joined this virtual room share materials or documents, thereby a virtual meeting close to a real meeting can be held. Such information sharing system allows an individual user to share a content of his or her own document in the virtual room or to import a content of a document being shared in the virtual room as his or her own document.

### SUMMARY

Embodiments of the present disclosure describe a content management server, an information sharing system, and a communication control method. The content management server for managing data of content shared by a plurality of communication terminals in a virtual room, the plurality of communication terminals include a first communication terminal and a second communication terminal, receives an invitation transmission request indicating a request to transmit an invitation for participating in the virtual room to the second communication terminal from the first communication terminal, and causes the second communication terminal to participate in the virtual room in response to receiving a participation request indicating a request for participation in the virtual room transmitted by the second communication terminal.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic diagram illustrating an overview of an information sharing system, according to an embodiment of the present disclosure;

FIG. 2 is a block diagram illustrating an example of a hardware configuration of a personal terminal, a shared terminal, and a content management server of the information sharing system, according to an embodiment of the present disclosure;

FIG. 3 is a block diagram illustrating an example of a functional configuration of the personal terminal, the shared terminal, and the content management server of the information sharing system, according to an embodiment of the present disclosure;

FIG. 4A is a conceptual diagram illustrating a virtual room management table;

FIG. 4B is a conceptual diagram illustrating a destination management table;

FIG. 4C is a conceptual diagram illustrating a schedule management table;

FIG. 5 is a sequence diagram illustrating a process of displaying a participant selection screen;

FIG. 6 is a sequence diagram illustrating a process of generating a personal electronic canvas in response to accepting an invitation to a virtual room;

FIG. 7 is a diagram illustrating a participant selection screen displayed on a terminal of a meeting organizer; and

FIGS. 8A to 8D are diagrams illustrating a screen displayed on an invitation destination terminal.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

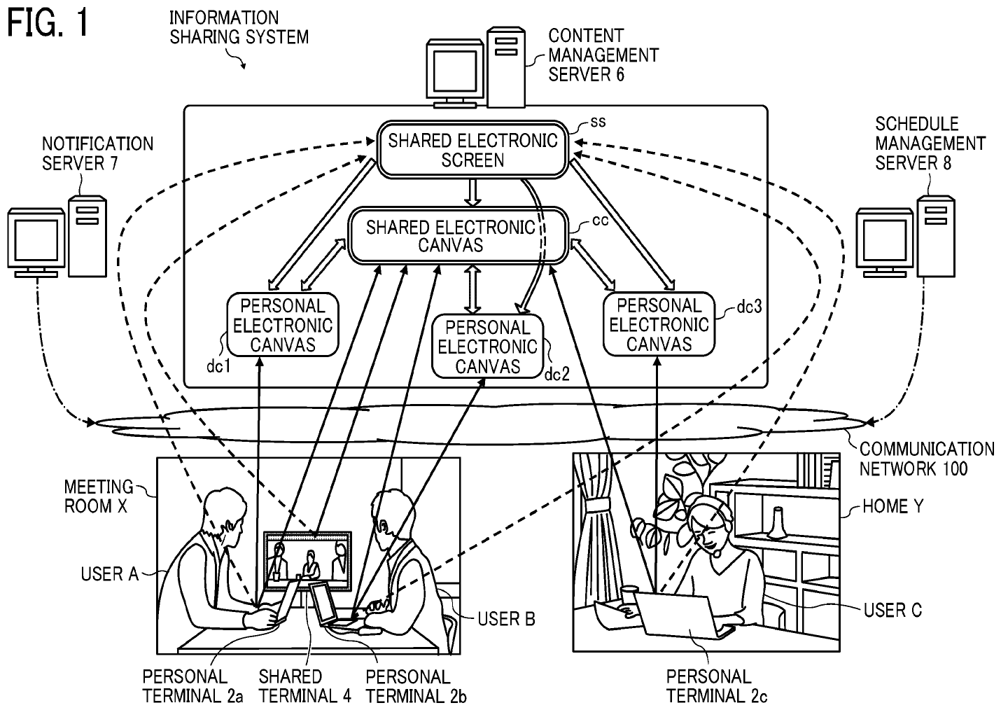

An embodiment of the present disclosure is described with reference to FIG. 1 to FIG. 8D.

With reference to FIG. 1, an overview of an information sharing system according to the present embodiment is described. FIG. 1 is a schematic diagram illustrating an overview of the information sharing system according to the present embodiment. FIG. 1 illustrates a case in which a user A and user B who are in a meeting room X of a company and a user C who is at home Y are conducting a remote meeting by using the information sharing system. The user A uses a personal terminal 2a in the meeting room X, and the user B uses a personal terminal 2b in the meeting room X. Further, a shared terminal 4 that can be shared by multiple users is provided in the meeting room X. On the other hand, the user C uses a personal terminal 2c at the home Y In the following description, the personal terminal 2a, the personal terminal 2b, and the personal terminal 2c are collectively referred to as a “personal terminal 2” or “personal terminals 2”, unless these terminals need to be distinguished from each other.

The personal terminal 2 is a computer that a user can use individually or exclusively and whose screen is viewed by the user individually. The personal terminal 2 is not limited to being privately-owned. The personal terminal 2 may be public, private, non-profit, rental or any other type of ownership terminal in which a user may individually or exclusively use the terminal and whose screen is viewed by the user individually. The shared terminal 4 is a computer that multiple users can use together and whose screen is viewed by the multiple users. Examples of the personal terminal 2 and the shared terminal 4 include a tablet terminal, a smartphone, a personal computer (PC), a personal digital assistant (PDA), a smartwatch, an electronic whiteboard, an electronic television, a game apparatus, a multifunction peripheral (MFP) having a copier function, and a car navigation system. Each of the personal terminals 2 and the shared terminal 4 is an example of a communication terminal (or an information processing terminal).

Each of the personal terminals 2 and the shared terminal 4 can communicate with the content management server 6 through a communication network 100 such as the internet. The communication network 100 is, for example, one or more local area networks (LANs) inside the firewall. In another example, the network N includes the internet that is outside the firewall in addition to the LAN. In another example, the communication network 100 further includes a virtual private network (VPN) and/or a wide-area Ethernet (registered trademark). The communication network 100 is any one of a wired network, a wireless network, and a combination of the wired network and the wireless network. In a case where the shared terminal 4, the personal terminal 2 or the content management server 6 connects to the communication network 100 through a mobile phone network such as 3G, Long Term Evolution (LTE), 4G, the LAN can be omitted.

The content management server 6 is a computer having a function as a web server (or hypertext transfer protocol (HTTP) server) that stores and manages data of contents to be transmitted to the personal terminal 2 and the shared terminal 4. The content management server 6 includes a storage unit 6000 that stores storage locations (or storage areas) for implementing a personal electronic canvas that can be accessed only from each second terminal 2. More specifically, only the second terminal 2a, the second terminal 2b and the second terminal 2c can access a personal electronic canvas dc1, a personal electronic canvas dc2 and a personal electronic canvas dc3 respectively. In the following description, the personal electronic canvas dc1, the personal electronic canvas dc2 and the personal electronic canvas dc3 are collectively referred to as a “personal electronic canvas dc”, unless these canvases need to be distinguished from each other.

The content management server 6 may support cloud computing. The “cloud computing” refers to internet-based computing where resources on a network are used or accessed without identifying specific hardware resources.

Further, the storage unit 6000 of the content management server 6 includes a storage location (or a storage area) for implementing a shared electronic canvas cc that can be accessed from each of the personal terminals 2. Furthermore, the storage unit 6000 of the content management server 6 includes a storage location (or a storage area) for implementing a shared electronic screen ss that can be accessed from each of the personal terminals 2.

In this disclosure, the “electronic canvas” is not a plain-woven thick cloth but a virtual space generated in the storage location (or the storage area) in the storage unit 6000 of the content management server 6. For example, the electronic canvas can be accessed by using a web application for an electronic canvas, the web application having a function of allowing a user to view and edit a content with the canvas element and JavaScript (registered trademark). The “web application” refers to software used on a web browser. The web application is implemented by a program written in a script language such as JavaScript (registered trademark) that operates on a web browser and a program on a web server side, which operates in cooperation with each other. Further, the web application refers to a mechanism that implements such software. The personal electronic canvas and the shared electronic canvas have infinite areas within the range of the storage area in the storage unit 6000.

In addition, the “electronic screen” is not a white screen for projecting a movie or a slide image for viewing but a virtual space generated in a storage location (or storage area) in the storage unit 6000 of the content management server 6. Different from the electronic canvas, the electronic screen has a function of holding data of a content to be transmitted (distributed) to the personal terminals 2 and the shared terminal 4 and holding the previous content until acquiring the next content. The electronic screen can be accessed by using a web application for the electronic screen, the web application having a function of allowing a user to view content.

Furthermore, the “personal electronic canvas” is an electronic space dedicated to each of the users participating in the remote meeting. Each user's personal terminal 2 can only access each individual electronic canvas, and browsing and editing (input, deletion, copying, etc.) of contents such as characters and images can be performed. The “shared electronic canvas” refers to an electronic space that users participating in the remote meeting use together or share. Any of the personal terminals 2 of the users can access the shared electronic canvas, which allows the users to view and/or edit (input, delete, copy, etc.) contents such as characters and images.

The “shared electronic screen” refers to an electronic space shared by users participating in the remote meeting. Any of the personal terminals 2 of the users can access the shared electronic screen, which allows the users to view a shared screen held by the shared electronic screen. However, unlike the personal electronic canvas and the shared electronic canvas, the shared electronic screen has a simple function of holding data of content to be transmitted (distributed) to the personal terminals 2 and the shared terminal 4 and holding the previous content before acquiring the next content. For example, in a case where data of a content is transmitted from the personal terminal 2a to the shared electronic screen ss and thereafter data of a content is transmitted from the personal terminal 2b to the shared electronic screen ss, data of a content held by the shared electronic screen ss is the data received latest.

The content management server 6 stores, for each of virtual rooms, information (data) such as contents developed on the shared electronic screen ss, the shared electronic canvas cc, and the personal electronic canvas dc in association with the corresponding virtual room. Thereby, even when the content management server 6 manages multiple virtual rooms, data of a content are not communicated over different virtual rooms.

Each personal terminal 2 causes the above-described web application operating on the web browser installed in the personal terminal 2 to display a content of the personal electronic canvas dc, the shared electronic canvas cc, and the shared electronic screen ss.

The notification server 7 is a server that transmits an invitation indicating a notification to invite to a specific virtual room to each personal terminal 2.

The schedule management server 8 is a server for managing a schedule of the user of each personal terminal 2. Each user registers his/her schedule.

Although FIG. 1 illustrates a case where the remote meeting is held between two sites (e.g., the meeting room X and the home Y), this case is just an example. In another example, a meeting is held at one site. In still another example, a remote meeting is performed at three or more sites.

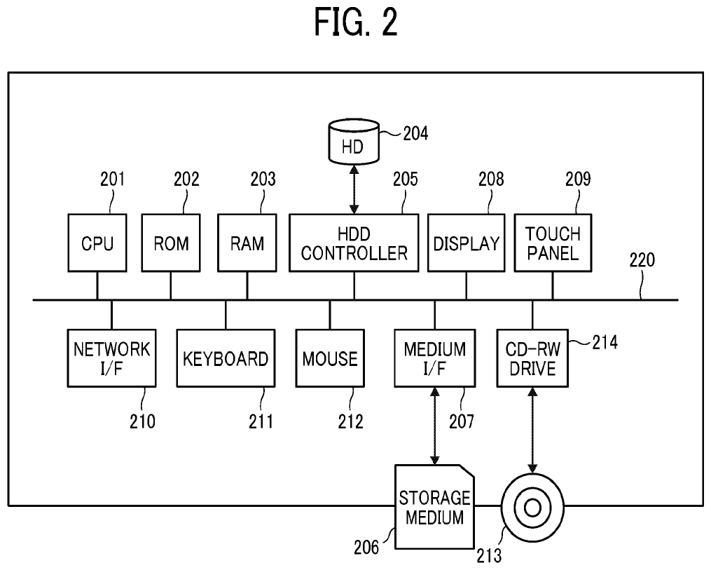

With reference to FIG. 2, a description is given of an example of a hardware configuration of the personal terminal 2, the shared terminal 4, and the content management server 6 of the information sharing system. FIG. 2 is a block diagram illustrating an example of a hardware configuration of the personal terminal 2, the shared terminal 4, and the content management server 6 of the information sharing system.

As illustrated in FIG. 2, the personal terminal 2 includes a central processing unit (CPU) 201, a read only memory (ROM) 202, a random access memory (RAM) 203, a hard disc (HD) 204, a hard disc drive (HDD) controller 205, a storage medium 206, a medium interface (I/F) 207, a display 208, a touch panel 209, a network I/F 210, a keyboard 211, a mouse 212, a compact disc rewritable (CD-RW) drive 214, and a bus line 220.

The CPU 201 controls entire operation of the personal terminal 2. The ROM 202 stores a program to boot the CPU 201. The RAM 203 is used as a work area for the CPU 201. The HD 204 stores various data such as a control program. The HDD controller 205 controls reading and writing of various data from and to the HD 204 under control of the CPU 201. The medium I/F 207 controls reading and writing (storing) of data from and to the storage medium 206 such as a flash memory. The display 208 displays various information such as a cursor, menu, window, character, or image. The touch panel 209 is one example of an input device (input means) that allows a user to operate the personal terminal 2 by touching a screen of the display 208. The network I/F 210 is an interface that controls communication of data through the communication network 100. The keyboard 211 is one example of an input device (input means) provided with a plurality of keys for allowing a user to input characters, numerals, or various instructions. The mouse 212 is one example of an input device (input means) that allows a user to select a specific instruction or execution, select a target for processing, or move a cursor being displayed. The CD-RW drive 214 reads and writes various data to and from a CD-RW 213, which is one example of a removable storage medium.

If the personal terminal 2 can communicate with the user, the display 208, the touch panel 209, the keyboard 211, or the mouse 212 may be provided separately from the personal terminal 2.

Since the shared terminal 4, the content management server 6, the notification server 7, and the schedule management server 8 have the same hardware configuration as that of the personal terminal 2, description of these hardware configurations is omitted. Hereinafter, each configuration illustrated in FIG. 2 is described as a configuration common to the personal terminal 2, the shared terminal 4, the content management server 6, the notification server 7, and the schedule management server 8.

Further, the program described above may be recorded on a storage medium such as a compact disc-recordable (CD-R) or a digital versatile disc-recordable (DVD-R) and distributed domestically or overseas. Instead of the CD-RW drive, a DVD-R drive or the like may be used. Each of the personal terminal 2, the shared terminal 4, the notification server 7, the schedule management server 8, and the content management server 6 can be configured by a single computer or a plurality of computers to which divided portions (functions, means, or storage units) are allocated.

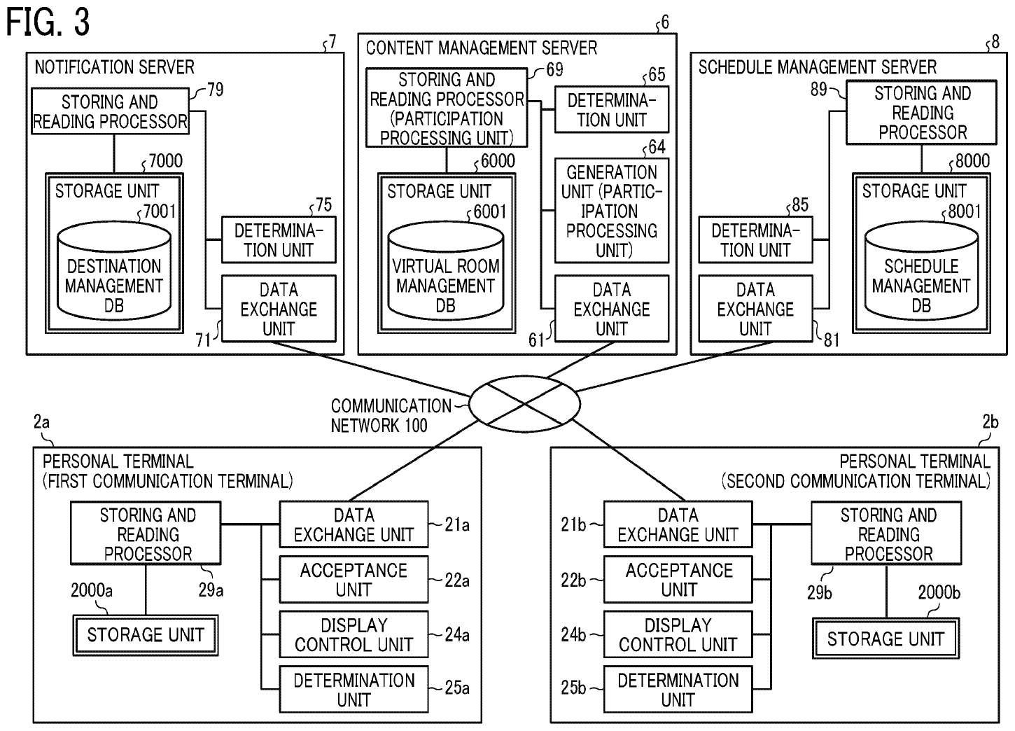

With reference to FIG. 3, a description is given of an example of a functional configuration of each of the personal terminal 2, the shared terminal 4, and the content management server 6 of the information sharing system. FIG. 3 is a block diagram illustrating an example of a functional configuration of the personal terminal 2, the shared terminal 4, and the content management server 6 of the information sharing system.

First, a description is given of an example of a functional configuration of the personal terminal 2a. As illustrated in FIG. 3, the personal terminal 2a includes a data exchange unit 21a, an acceptance unit 22a, a display control unit 24a, a determination unit 25a, and a storing and reading processor 29a. These units are functions that are implemented by or that are caused to function by operating any of the hardware elements illustrated in FIG. 2 in cooperation with the instructions of the CPU 201 according to the control program expanded from the HD 204 to the RAM 203. The personal terminal 2a further includes a storage unit 2000a, which is implemented by the RAM 203 and the HD 204 illustrated in FIG. 2.

Next, a detailed description is given of each functional configuration of the personal terminal 2a.

The data exchange unit 21a exchanges various data (or information) with other terminals, apparatuses, servers, etc. through the communication network 100. For example, the data exchange unit 21a receives, from the content management server 6, content data described in a hypertext markup language (HTML), Cascading Style Sheet (CSS), and JavaScript (registered trademark). In addition, the data exchange unit 21a transmits operation information input by the user to the content management server 6.

The acceptance unit 22a accepts various selections or instructions input by the user using the keyboard 211 and the mouse 212.

The display control unit 24a controls the display 208 to display contents of various images and screens.

The determination unit 25a performs various determinations.

The storing and reading processor 29a is implemented by instructions from the CPU 201 illustrated in FIG. 2 and the HDD controller 205, the medium I/F 207, and the CD-RW drive 214, stores various data in the storage unit 2000a, the storage medium 206, and the CD-RW 213, and reads the various data from the storage unit 2000a, the storage medium 206, and the CD-RW 213.

The personal terminal 2b includes a data exchange unit 21b, an acceptance unit 22b, a display control unit 24b, a determination unit 25b, and a storing and reading processor 29b. These units are functions that are implemented by or that are caused to function by operating any of the hardware elements illustrated in FIG. 2 in cooperation with the instructions of the CPU 201 according to the control program expanded from the HD 204 to the RAM 203. The personal terminal 2b further includes a storage unit 2000b, which is implemented by the RAM 203 and the HD 204 illustrated in FIG. 2. The data exchange unit 21b, the acceptance unit 22b, the display control unit 24b, the determination unit 25b, the storing and reading processor 29b, and the storage unit 2000b are substantially the same as the data exchange unit 21a, the acceptance unit 22a, the display control unit 24a, the determination unit 25a and the storing and reading processor 29a in the personal terminal 2a, and therefore description thereof is omitted. In addition, since the personal terminal 2c and the shared terminal 4 have the same function as the personal terminal 2a, description thereof is omitted.

A description is now given of an example of a functional configuration of the content management server 6. As illustrated in FIG. 3, the content management server 6 includes a data exchange unit 61, a generation unit 64, a determination unit 65, and a storing and reading processor 69. These units are functions that are implemented by or that are caused to function by operating any of the hardware elements illustrated in FIG. 2 in cooperation with the instructions of the CPU 201 according to the control program expanded from the HD 204 to the RAM 203. The content management server 6 further includes a storage unit 6000, which is implemented by the RAM 203 and the HD 204 illustrated in FIG. 2.

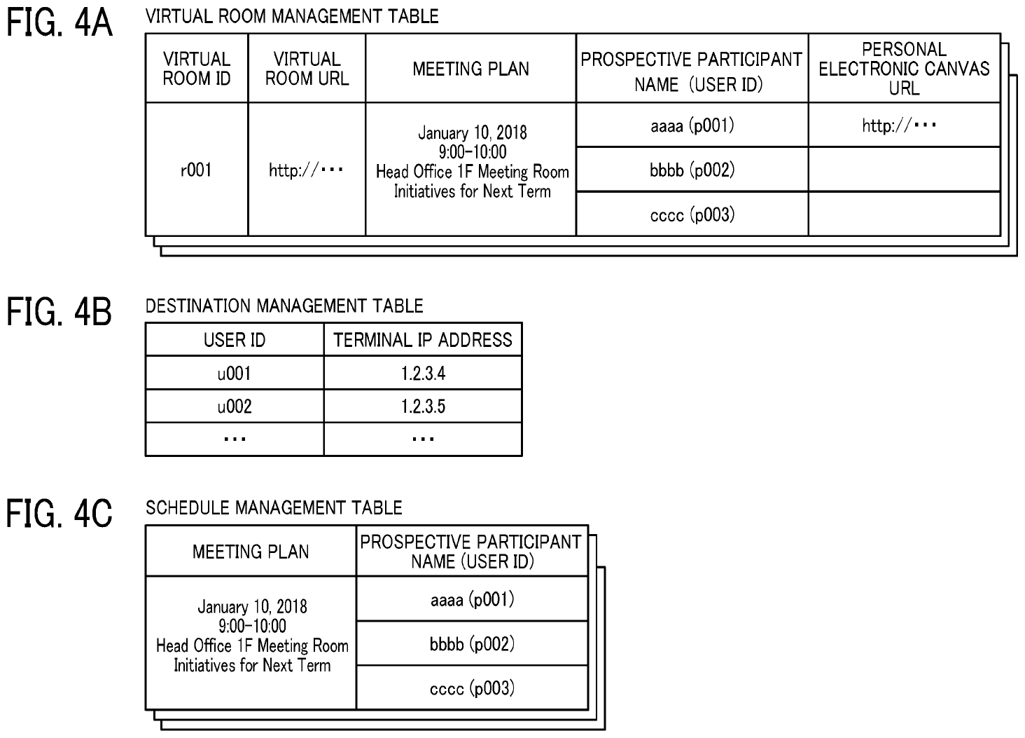

FIG. 4A is a conceptual diagram illustrating a virtual room management table. The storage unit 6000 includes a virtual room management data base (DB) 6001 that stores the virtual room management table as illustrated in FIG. 4A. In the virtual room management table, a virtual room identifier (ID), a virtual room Uniform Resource Locator (URL), a meeting plan, a name and user ID of prospective participant, and a URL of the personal electronic canvas are stored in association with each other. Among these, the virtual room ID is an example of virtual room identification information for identifying the virtual room. The URL of the virtual room is an example of location information indicating the location of the virtual room on the internet or the like. The meeting plan is information on a meeting or the like that is to be held in the virtual room, and includes a subject of the meeting, a date and time of the meeting, and a place for the meeting. The prospective participant name indicates the name of a user who plans to participate in the meeting in the virtual room. When a prospective participant actually participates in the meeting, the name of prospective participant is managed as “participant name”. The user ID is an example of user identification information for identifying a user indicated by a prospective participant name (participant name). The user identification information includes a driver's license number, an identification number in social security or tax number system, and the like. The URL of the personal electronic canvas is an example of location information indicating a location of each personal electronic canvas on the internet or the like.

Next, a detailed description is given of each functional unit of the content management server 6.

The data exchange unit 61 is implemented by instructions from the CPU 201 and exchanges various data (or information) with the other terminals, devices, servers, etc. through the communication network 100.

The generation unit 64 is implemented by instructions from the CPU 201 and generates the virtual room ID, the virtual room URL, the personal electronic canvas URL, and the like.

The determination unit 65 is implemented by instructions from the CPU 201 and makes various determinations.

The storing and reading processor 69 is implemented by instructions from the CPU 201 and stores various data in the storage unit 6000 and reads the various data from the storage unit 6000.

Note that the generation unit 64 and the storing and reading processor 69 implement a participation processing unit.

A functional configuration of the notification server 7 is described below. As illustrated in FIG. 3, the notification server 7 includes a data exchange unit 71, a determination unit 75, and a storing and reading processor 79. These units are functions that are implemented by or that are caused to function by operating any of the hardware elements illustrated in FIG. 2 in cooperation with the instructions of the CPU 201 according to the control program expanded from the HD 204 to the RAM 203. Further, the notification server 7 includes a storage unit 7000 implemented by the RAM 203 and the HD 204 illustrated in FIG. 2.

FIG. 4B is a conceptual diagram illustrating a destination management table. The storage unit 7000 includes a destination management DB 7001 that stores the destination management table as illustrated in FIG. 4B. In the destination management table, a user ID to identify the user of the personal terminal 2 that is the destination of the invitation transmitted in step S36 described later and the internet protocol (IP) address of the personal terminal 2 that is the destination are stored in association with each other. The user ID and the IP address are acquired by the notification server 7 through communication between the personal terminal 2 and the notification server 7 before processing in step S36 described later.

Next, a detailed description is given of each functional unit of the notification server 7.

The data exchange unit 71 is implemented by instructions from the CPU 201 and exchanges various data (or information) with other terminals, devices, servers, etc. through the communication network 100.

The determination unit 75 is implemented by instructions from the CPU 201 and makes various determinations.

The storing and reading processor 79 is implemented by instructions from the CPU 201 and stores various data in the storage unit 7000 and reads the various data from the storage unit 7000.

A description is now given of an example of a functional configuration of the schedule management server 8. As illustrated in FIG. 3, the schedule management server 8 includes a data exchange unit 81, a determination unit 85, and a storing and reading processor 89. These units are functions that are implemented by or that are caused to function by operating any of the hardware elements illustrated in FIG. 2 in cooperation with the instructions of the CPU 201 according to the control program expanded from the HD 204 to the RAM 203. Further, the schedule management server 8 includes a storage unit 8000 implemented by the RAM 203 and the HD 204 illustrated in FIG. 2.

FIG. 4C is a conceptual diagram illustrating a schedule management table. The storage unit 8000 includes a schedule management DB 8001 that stores the schedule management table as illustrated in FIG. 4C. In the schedule management table, the same data as the meeting plan, the prospective participants, and the user ID in the virtual room management table illustrated in FIG. 4A are stored for each meeting that has been scheduled. A meeting plan ID for identifying the meeting plan may be stored in addition to the date in the meeting plan field. The meeting plan ID may be stored instead of the date, etc. in the virtual room management table illustrated in FIG. 4A.

Next, a detailed description is given of each functional unit of the schedule management server 8.

The data exchange unit 81 is implemented by instructions from the CPU 201 and exchanges various data (or information) with other terminals, devices, servers, etc. through the communication network 100.

The determination unit 85 is implemented by instructions from the CPU 201 and makes various determinations.

The storing and reading processor 89 is implemented by instructions from the CPU 201 and stores various data in the storage unit 8000 and reads the various data from the storage unit 8000.

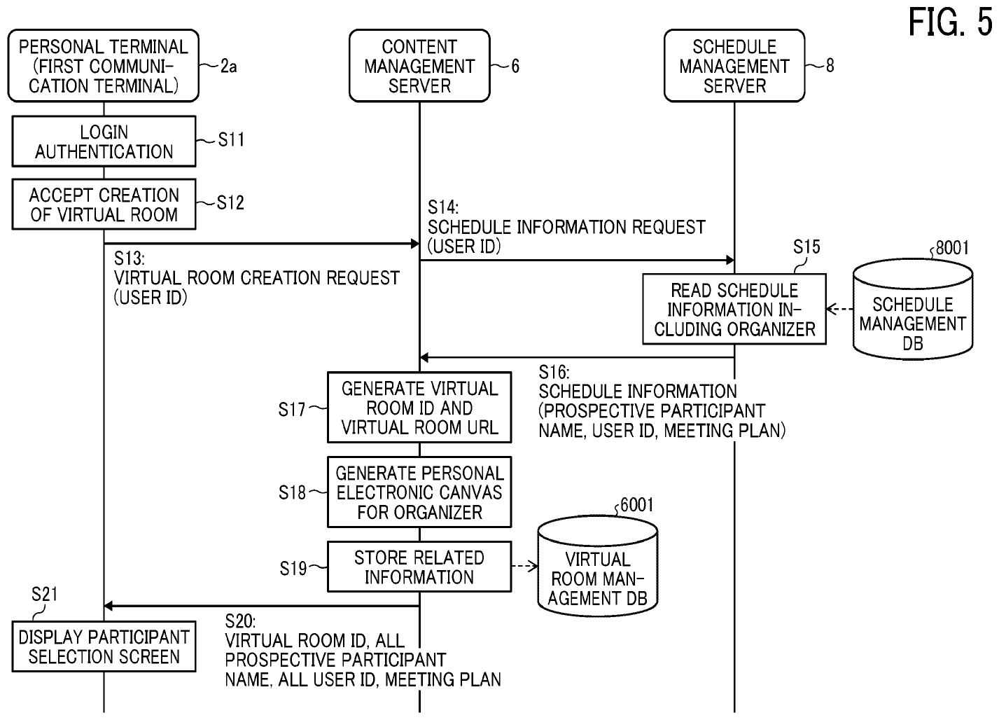

A description is given now of processes according to the present embodiment, with reference to FIG. 5 to FIG. 8D. In the description, the personal terminal 2a is an example of a first communication terminal, and the personal terminal 2b is an example of a second communication terminal.

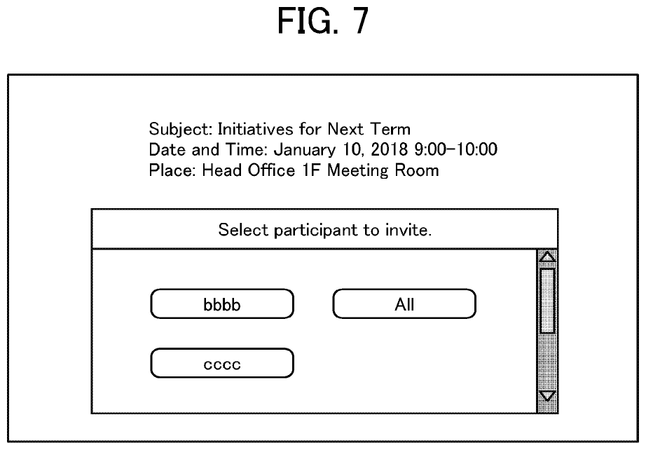

A process to display a participant selection screen for selecting a participant, in response to a request from an organizer to create a virtual room for remote meeting, is described with reference to FIG. 5 and FIG. 7. FIG. 5 is a sequence diagram illustrating a display process of the participant selection screen.

As illustrated in FIG. 5, the personal terminal 2a performs login authentication of the organizer in step S11. For example, authentication is performed when the personal terminal 2a receives inputs of a user ID and a password from the organizer.

Assuming that authentication is successful, the acceptance unit 22a accepts a request for creating the virtual room input by the organizer in step S12. For example, a button for creating the virtual room is displayed on the personal terminal 2a, and the acceptance unit 22a accepts the request for creation of the virtual room when the button is pressed by the organizer. Thereby, the data exchange unit 21a transmits the virtual room creation request to the content management server 6 in step S13. The virtual room creation request includes a user ID for identifying the organizer (creation requester). The data exchange unit 61 of the content management server 6 receives the virtual room creation request.

In step S14, the data exchange unit 61 of the content management server 6 transmits schedule information request indicating that the schedule of the organizer is requested to the schedule management server 8. This schedule information request includes the organizer's user ID, which is received in S13. Thereby, the data exchange unit 81 of the schedule management server 8 receives the schedule information request.

In step S15, the storing and reading processor 89 of the schedule management server 8 reads the schedule information including the organizer as the prospective participant by searching the schedule management DB 8001 using the organizer's user ID as a search key. This schedule information includes meeting plan, names of prospective participants, and a user ID for identifying each prospective participant, as illustrated in FIG. 4C, for one or more meetings that the organizer is scheduled to attend. In step S16, the data exchange unit 81 transmits the schedule information read in step S15 to the content management server 6. Thereby, the data exchange unit 61 of the content management server 6 receives the schedule information.

In step S17, the generation unit 64 of the content management server 6 generates a virtual room ID for identifying the virtual room and a virtual room URL for designating a location of the virtual room. In step S18, the generation unit 64 generates a URL of the personal electronic canvas dc1 accessible by the personal terminal 2a that requested to create the virtual room in S13. Then, the storing and reading processor 69 stores the virtual room ID and virtual room URL generated in step S17, the schedule information received in step S16 (meeting plan, each prospective participant name (each user ID)), and organizer's personal electronic canvas URL created in step S18, in association with each other in the virtual room management DB 6001, as illustrated in FIG. 4A (S19). The URL of the personal electronic canvas illustrated in FIG. 4A is stored only for the organizer (aaaa) at this time.

In step S20, the data exchange unit 61 transmits the virtual room ID, the names of all prospective participants, the user IDs of all prospective participants, and the meeting plan to the personal terminal 2a. In step S21, the data exchange unit 21a of the personal terminal 2a receives the data described above.

In step S21, the display control unit 24a of the personal terminal 2a displays the participant selection screen as illustrated in FIG. 7 on the display 208. FIG. 7 is a diagram illustrating a participant selection screen displayed on the terminal of the meeting organizer. On the participant selection screen, the meeting plan (meeting subject, date and time, meeting place) is displayed at the top. At the bottom of the participant selection screen, name icons (“bbbb”, “cccc”) each indicating the name of the prospective participant to be pressed when inviting the corresponding prospective participant to the virtual room, and an “All” icon to be pressed when inviting all prospective participants at once are displayed.

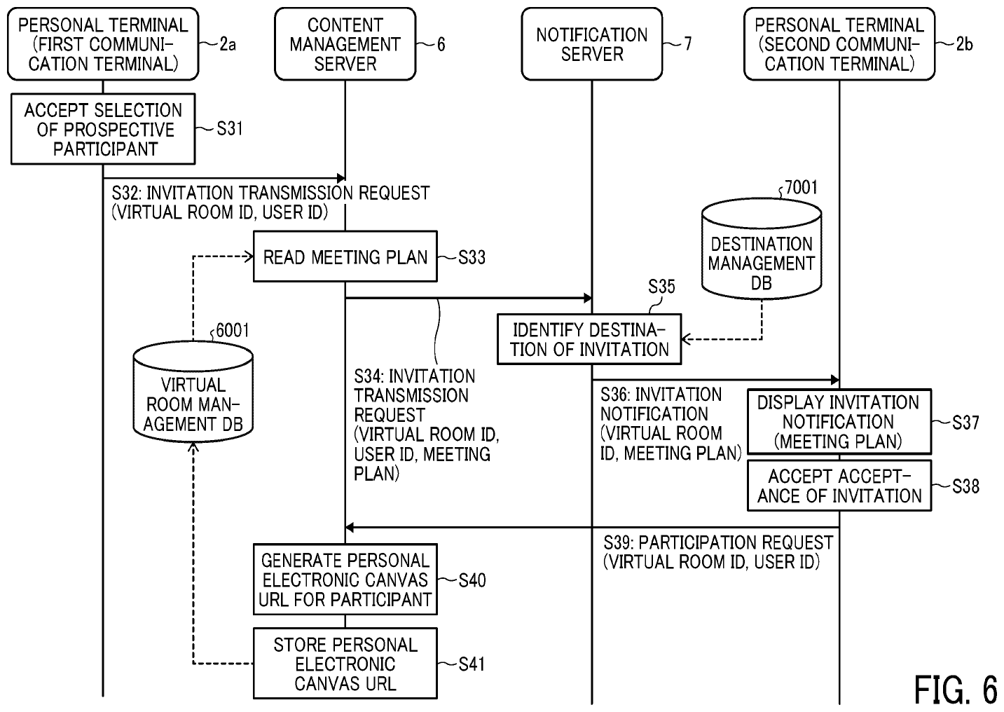

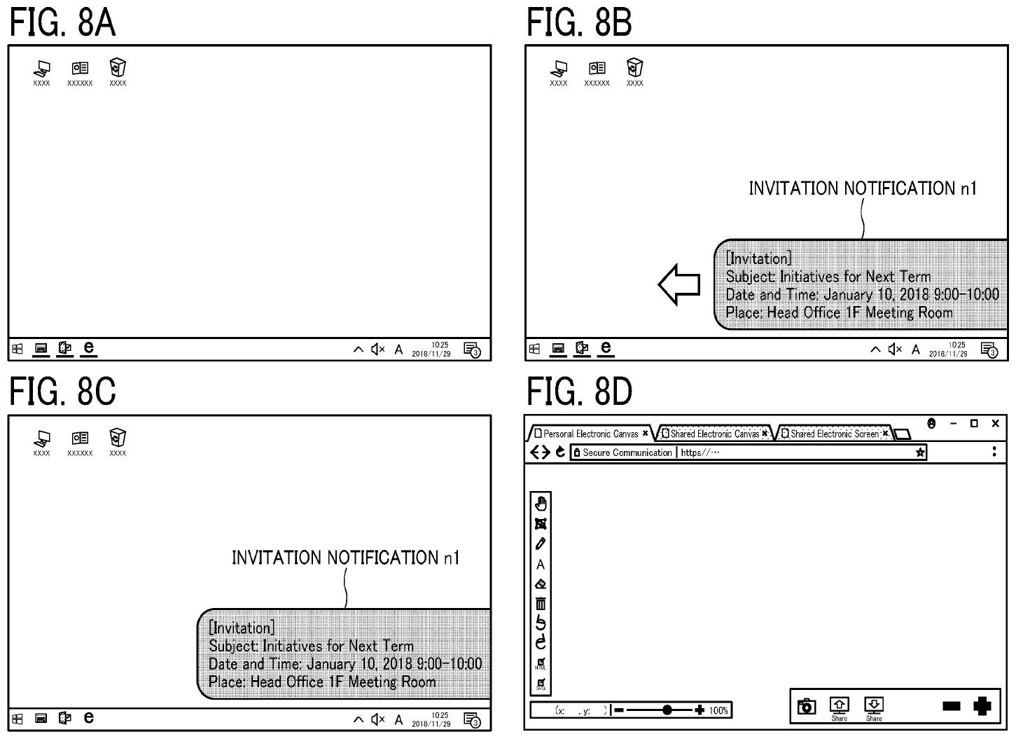

A process when the prospective participant accepts the invitation to the virtual room from the organizer and makes a participation request to the content management server 6 is described with reference to FIG. 6, FIG. 7, FIG. 8A, FIG. 8B, FIG. 8C, and FIG. 8D. FIG. 6 is a sequence diagram illustrating the process in the case of accepting the invitation to the virtual room.

In FIG. 7, for example, when the organizer wants to invite a prospective participant (bbbb) who is the owner of the personal terminal 2b to the virtual room, the organizer presses the “bbbb” icon. The acceptance unit 22a accepts the selection of a prospective participant “bbbb” in step S31 when the organizer presses the “bbbb” icon. In step S32, the data exchange unit 21a transmits an invitation transmission request to a personal terminal of a prospective participant (for example, the personal terminal 2b), to the content management server 6. The invitation transmission request includes the user ID of each selected prospective participant in S31 and the virtual room ID received in step S20. Thereby, the data exchange unit 61 of the content management server 6 can identify the personal terminal 2b of the destination of invitation by receiving the invitation transmission request.

In step S33, the storing and reading processor 69 of the content management server 6 reads the corresponding meeting plan by searching the virtual room management DB 6001 using the virtual room ID received in step S32 as a search key to obtain the meeting plan associated with the virtual room ID. In step S34, the data exchange unit 61 transmits the invitation transmission request to the notification server 7. The invitation transmission request includes not only the virtual room ID and the user ID received in step S32 but also the meeting plan read in step S33. Thereby, the notification server 7 receives the invitation transmission request.

In step S35, the storing and reading processor 79 of the notification server 7 reads the corresponding IP address by searching the destination management DB 7001 using the user ID received in step S34 as a search key. In step S36, the data exchange unit 71 transmits the invitation to a specific virtual room to the personal terminal 2b. This invitation includes the virtual room ID and the meeting plan received in step S34. Thereby, the data exchange unit 21b of the personal terminal 2b receives the invitation.

A screen displayed on the personal terminal 2b, which is the destination of the invitation, is described with reference to FIG. 8. FIG. 8 is a diagram illustrating the screen displayed on an invitation destination terminal.

In the personal terminal 2b, the display control unit 24b displays a general PC background screen on the display 208 of the personal terminal 2b as illustrated in FIG. 8A. In step S36, when the data exchange unit 21b receives the invitation in the status illustrated in FIG. 8A, the display control unit 24b displays the invitation notification n1 as illustrated in FIGS. 8B to 8C. In step S37, the invitation notification n1 slides in on the screen like a push notification. The invitation notification n1 includes the meeting plan received in step S36. In steps S36 and S37, in case the invitation notification is sent using the push notification, even if the web browser is not activated, the invitation notification can be received whenever the personal terminal is in use since information on each user that is managed in the destination management table illustrated in FIG. 4B can be used for push notification. The push function is executed as long as operating system (OS) of the personal terminal is activated, even if the (web) browser is not activated. In step S37, the invitation notification n1 slides in on the screen, but the invitation notification n1 may be displayed in other ways, for example, at a specific place such as the lower right of the screen of the personal terminal without sliding in, or the invitation notification n1 may be displayed so that the notification is made gradually visible from the translucent state.

In step S38, in response to pressing of the invitation notification n1 with the mouse 212 or the like by the user B of the personal terminal 2b, the acceptance unit 22b receives acceptance of the invitation. In step S39, the data exchange unit 21b transmits a participation request to the content management server 6. The participation request includes the virtual room ID and the user ID of user B. The virtual room ID transmitted in step S39 is the virtual room ID received in step S36. Thereby, the data exchange unit 61 of the content management server 6 receives the participation request. In step S40, the generation unit 64 of the content management server 6 generates a URL of the personal electronic canvas for the invitation destination terminal (personal terminal 2b). In step S41, the storing and reading processor 69 stores the URL of the personal electronic canvas generated in step S40 and the virtual room ID associated with the meeting plan read in step S33 in the virtual room management DB 6001.

Generally, in order for each user to participate in the virtual room, the organizer or the like must inform each prospective participant of the URL for participating in the virtual room by e-mail or the like. In this case, the organizer must start the mailer on the personal terminal, find the address of the prospective participant, and send an e-mail to the personal terminal of each prospective participant, which takes time and effort. On the other hand, according to the present embodiment, the organizer only has to press the icon indicating the name of the prospective participant to be invited as illustrated in FIG. 7. The time and effort of the organizer can be reduced. The processes in steps S12 and S13 do not need to be performed by the personal terminal 2a of the organizer according to a request from the organizer. Any person who first requests to create a virtual room among those who plan to participate in the virtual room may execute the processes using any terminal.

Further, as illustrated in FIGS. 8A, 8B, and 8C, in the personal terminal 2b that is the destination of the invitation, the invitation notification n1 slides in on the screen like a push notification. Therefore, the prospective participant can instantly know that the meeting in the virtual room is planned. Furthermore, since the prospective participant can participate in the virtual room only by pressing the invitation notification n1 (steps S38 to S41), the time and effort for the prospective participant can be reduced.

The above-described embodiments are illustrative and do not limit the present disclosure. For example, elements and/or features of different illustrative embodiments may be combined with each other and/or substituted for each other within the scope of the present disclosure. Thus, numerous additional modifications and variations are possible in light of the above teachings.

In addition, although the description of the embodiments given heretofore is of a case where the Canvas element of HTML is used, alternatively, WebGL, SVG (scalable vector graphics), FLASH (registered trademark), etc. can be used.

Although the description given heretofore of the embodiments is of a case where each of the personal electronic canvas and the shared electronic canvas is an infinite electronic canvas, the present disclosure is not limited to this. Alternatively, each of the personal electronic canvas and the shared electronic canvas can be a finite electronic canvas.

In addition, the personal electronic canvas can be a limited finite electronic canvas displayed within the displayable range of the display 208 of the personal terminal 2. Similarly, the shared electronic canvas can be a limited finite electronic canvas displayed within the displayable range of the display 208 of the shared terminal 4.

Further, in the example of FIG. 1, the shared terminal 4 and the shared electronic canvas cc can be omitted.

Each of the functions (illustrated in FIG. 3) of the above-described embodiments can be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

Any one of the above-described operations may be performed in various other ways, for example, in an order different from the one described above.

What is claimed is:

1. A content management server for managing data of content to be shared by a plurality of communication terminals in a virtual room, the plurality of communication terminals including a first communication terminal and a second communication terminal, the content management server comprising:
first circuitry configured to;
receive, from the first communication terminal, an invitation transmission request indicating a request to transmit an invitation for participating in the virtual room to the second communication terminal; and
cause the second communication terminal to participate in the virtual room in response to receiving a participation request indicating a request for participating in the virtual room from the second communication terminal.

2. The content management server of claim 1, wherein the first circuitry is further configured to:
transmit an invitation transmission request to a notification server to cause the notification server to transmit the invitation for participating in the virtual room to the second communication terminal;
wherein,
the second communication terminal transmits the participation request in response to the invitation for participating in the virtual room transmitted from the notification server.

3. The content management server of claim 1, wherein the first circuitry is further configured to:
transmit, to the first communication terminal, user identification information for identifying one or more users, each user being a prospective participant in the virtual room; and
receive, from the first communication terminal, user identification information for identifying a user of the second communication terminal as a destination of the invitation for participating in the virtual room, the user of the second communication terminal being selected from among the one or more users each identified with the user identification information received at the first communication terminal.

4. The content management server of claim 3, wherein the first circuitry is further configured to:
transmit a schedule information request indicating a request for schedule information of one or more users who are scheduled to share the virtual room with the user of the first communication terminal, to a schedule management server that manages schedules of users;
receive user identification information for identifying the one or more users scheduled to share the virtual room, transmitted from the schedule management server in response to the schedule information request; and
transmit the user identification information for identifying the one or more users scheduled to share the virtual room as the user identification information for identifying the one or more users each being a prospective participant in the virtual room, to the first communication terminal.

5. The content management server of claim 4, wherein the first circuitry is further configured to:
receive a creation request for creating the virtual room from the first communication terminal; and
transmit the schedule information request to the schedule management server in response to the creation request.

6. The content management server of claim 1, wherein the first circuitry is further configured to:
create a personal electronic canvas accessible only by the second communication terminal or the user of the second communication terminal as a process for causing the second communication terminal to participate in the virtual room.

7. The content management server of claim 6, wherein
the personal electronic canvas is associated with a shared electronic screen accessible by a plurality of users who participate in the virtual room.

8. An information sharing system comprising:
the content management server of claim 1; and
the second communication terminal.

9. The information sharing system of claim 8, wherein
the second communication terminal comprises:
second circuitry configured to;
display on a display, an invitation notification in response to receiving the invitation for participating in the virtual room from the notification server.

10. The information sharing system of claim 9, wherein the second circuitry is further configured to;
transmit the participation request to the content management server in response to receiving an operation on the displayed invitation notification.

11. An information sharing system for sharing content by a plurality of communication terminals in a virtual room, the plurality of communication terminals including a first communication terminal and a second communication terminal, the information sharing system comprising:
circuitry configured to;
receive, from the first communication terminal, an invitation transmission request indicating a request to transmit an invitation for participating in the virtual room to the second communication terminal;
transmit the invitation for participating in the virtual room to the second communication terminal; and
cause the second communication terminal to participate in the virtual room in response to receiving a participation request indicating a request for participation in the virtual room from the second communication terminal.

12. A communication control method for managing data of content to be shared by a plurality of communication terminals in a virtual room, the plurality of communication terminals including a first communication terminal and a second communication terminal, the communication control method comprising:
receiving, from the first communication terminal, an invitation transmission request indicating a request to transmit an invitation for participating in the virtual room to the second communication terminal; and
causing the second communication terminal to participate in the virtual room in response to receiving a participation request indicating a request for participating in the virtual room from the second communication terminal.

13. The communication control method of claim 12, further comprising:
transmitting an invitation transmission request to a notification server to cause the notification serer to transmit the invitation for participating in the virtual room to the second communication terminal; and
receiving the participation request from the second communication terminal, the participation request being transmitted in response to the invitation for participating in the virtual room from the notification server.

14. A non-transitory recording medium which, when executed by one or more processors, cause the processors to perform a communication control method for managing data of content to be shared by a plurality of communication terminals in a virtual room, the plurality of communication terminals including a first communication terminal and a second communication terminal, the communication control method comprising:
receiving, from the first communication terminal, an invitation transmission request indicating a request to transmit an invitation for participating in the virtual room to the second communication terminal; and
causing the second communication terminal to participate in the virtual room in response to receiving a participation request indicating a request for participating in the virtual room from the second communication terminal.

15. The non-transitory recording medium of claim 14, wherein the communication control method further comprises:
transmitting the invitation transmission request to a notification server for transmitting the invitation for participating in the virtual room to at least one communication terminal among the plurality of communication terminals; and
receiving the participation request from the communication terminal transmitted in response to the invitation for participating in the virtual room transmitted by the notification server.
